(19) United States
(12) Patent Application Publication
(10) Pub. No.: US 2002/0180577 A1
(43) Pub. Date: Dec. 5, 2002

(54) Winding body for receiving a winding for an electromagnetomechanical converter and electromagnetomechanical converter

(75) Inventors: Marcus Van Heyden, Schweinfurt (DE); Horst Oppitz, Dittelbrunn (DE); Jens Baumeister, Schweinfurt (DE); Edmund Grau, Poppenhausen (DE)

Correspondence Address: Thomas C. Pontani, Esq., Cohen, Pontani, Lieberman & Pavane, Suite 1210, 551 Fifth Avenue, New York, NY, 10176, US

(73) Assignee: Mannesmann Sachs AG

(21) Appl. No.: 10/192,027

(22) Filed: Jul. 10, 2002

Related U.S. Application Data
(63) Continuation-in-part of application No. 09/766,080, filed on Jan. 19, 2001.

(30) Foreign Application Priority Data
Jul. 13, 2001 (DE) 101 34 123.7

(51) Int. Cl. H01C 3/04

(52) U.S. Cl. 338/25

(57) ABSTRACT

A winding body has a winding area for receiving a winding, which winding area is formed by a winding carrier and two legs which define the winding area in axial direction and are connected with the winding carrier. A temperature sensor for measuring the temperature in the winding is arranged in the area of the winding carrier.

### RELATED APPLICATION

This application is a continuation-in-part of U.S. application Ser. No. 09/766,080, filed Jan. 19, 2001, the disclosure of which is incorporated herein by reference.

### BACKGROUND OF THE INVENTION

1. Field of the Invention

The present invention is directed to a winding body for receiving a winding for an electromagnetomechanical converter with a winding area for the winding, which winding area is formed by a winding carrier and two legs which define the winding area in axial direction and are connected with the winding carrier.

2. Description of the Related Art

Electromagnetomechanical converters are rotating electric machines which, with the aid of a magnetic field, either convert electrical energy into mechanical energy, based on the principle of a motor, or convert mechanical energy into electrical energy based on the principle of a generator.

Electric machines of this kind which can be constructed, for example, as synchronous machines or asynchronous machines have a stationary part, referred to as the stator, and a rotating part called the rotor. Depending on the type of construction of the electric machine, the rotor and stator are generally formed of a lamination stack comprising a yoke and a quantity of winding teeth. An electric winding which can have a plurality of coils is arranged in the slots between these winding teeth. When current flows through these windings, the magnetic field of the electric machine is generated.

The windings are associated with individual strands, the windings assigned to a common strand being connected to one another. In the case of three-phase machines, a total of m strands is provided) and current is applied with a phase offset of 360/m.

The lamination stack with its electromagnetic components is generally referred to as a magnetic circuit. The lamination stack can, for instance, be constructed in one part, which means that the yoke and the winding teeth are constructed as an individual structural component part. In other known magnetic circuit designs, the lamination stacks are constructed in two parts. This means that the yoke as well as the individual winding teeth are initially produced as separate structural component parts and are subsequently combined to form a common lamination stack.

The use of winding bodies for producing the windings and fastening them to the winding teeth is already known. A known winding body [developed by the present Applicant which has the features described in the introduction] is shown and described in FIG. 2.

In the case of one-part lamination stacks, two winding bodies are clamped into a winding machine and are then wound with the winding. Particularly in electric machines with short lengths, the winding, after its completion, can be removed from the winding machine and can be placed on the respective teeth of the lamination stack.

With two-pat lamination stacks, the winding bodies can initially be connected to a winding tooth and, combined in this way, can be inserted into the winding machine. Winding is then carried out resulting in a coil formed by the winding tooth, the two winding bodies and the actual winding. The coil produced in this way can subsequently be connected with the yoke. However, the winding can also be produced in the manner described with respect to the one-part lamination stack.

The stator or rotor of the electric machine is completed as soon as the respective winding ends have been connected in the desired manner.

An important parameter for operation of the electromagnetomechanical converter is current operating temperature. It is already known to outfit electromagnetomechanical converters with temperature gauges. When a predetermined maximum temperature is exceeded, a control unit, for example, can reduce the output of the electromagnetomechanical converter or deliberately switch it off Temperature gauges or temperature switches are usually arranged at a winding inside the winding body or in the thermal contact separate from the winding body. The stator temperature can be deduced from the temperature measured in this way and the rotor temperature, in turn, can be deduced from the stator temperature.

DE 41 42 180 C1 discloses an electric motor in which the field winding is carried by two stator poles. After the winding is produced, a thermal protection switch is arranged so as to contact the winding. The holder comprises two legs which are approximately parallel at a distance axially from the stator. One leg receives the field winding and the other leg carries the actual thermal protection switch on the side facing the winding. The thermal protection switch is pressed in order to produce a thermally locking contact against the winding. A disadvantage in this solution is that another step and also a special device are required for mounting the thermal protection switch after the field winding is arranged on the stator.

DD-PS 87 864 teaches a winding body made of plastic for fastening coils to stamped poles. The winding body has a winding area for the winding and two legs which define the winding area in axial direction and are connected to the winding carrier which is locked at the stator by a locking device. An arrangement for detecting an operating temperature of the winding is not provided at least in the area of the winding body. This also means that additional steps are required for receiving a temperature gauge.

Further, DE 299 08 718 U1 describes a winding body for a motor/generator which carries a winding in a winding area defined by two legs and has a connection device radially adjacent to the winding for connecting the ends of the winding of the coils by means of a plurality of electrically conducting terminal distributors. This device also has no means for detecting temperature.

### SUMMARY OF THE INVENTION

Proceeding from the prior art mentioned above, it is the object of the present invention to provide a temperature sensor at a winding for an electromagnetomechanical converter in a simple manner such that the disadvantages known from the prior art are avoided.

According to the invention, the temperature sensor for measuring the temperature in the winding is provided at the winding body itself, namely, in the area of the winding carrier, preferably in a cutout which is provided at the winding carrier. Additional steps for the arrangement and additional steps for its assembly are therefore obviated. The arrangement of the temperature sensor, for example, an NTC temperature sensor, inside the winding body protects the temperature sensor during the winding process and, when suitably arranged, ensures that the temperature sensor can be brought into contact with the winding (the copper) in a defined manner during subsequent operation. Examples of how the temperature sensor can be arranged inside the winding body are described more filly in the course of the description.

When the electromagnetomechanical converter is used as a rotary current or three-phase machine, for example, it has three phases, each of which can haves for example, six windings, although not exclusively. In a configuration of this kind, it may be advantageous to provide a temperature sensor in each of the phases, so that a converter of this type would have a total of three temperature sensors. However, the quantity of temperature sensors required is not limited to this specific quantity. One to three temperature sensors of this type can advantageously be provided per converter, the quantity of temperature sensors can also be varied depending upon requirements and application.

The winding body which is preferably made of plastic can be produced by a suitable method such as injection molding or the like, A corresponding cutout for the temperature sensor can easily be provided in the winding body during manufacture. In this case, the temperature sensor is introduced into the cutout at the start of the winding process. The winding can then be produced, and the temperature sensor is held securely in the cutout so as to be protected against damage. Further, by means of a suitable selection of the cutout geometry, the temperature sensor contacts the fully wound winding in a defined manner so that the temperature in the coil can be accurately determined and transmitted.

However, the invention is not limited to this specific example. It is also possible, for example, to arrange the temperature sensor in the winding body in a different manner. This can be carried out, for instance, by casting the temperature sensor in the winding body or the like.

One or more channels can preferably be provided in the winding carrier for guiding through the contacts of the temperature sensor. The contacts of the temperature sensor are inserted into and guided through these channels which, for example, can be oriented radially outward in the winding carrier. In this way, the temperature sensor can be connected in a simple manner with corresponding lines leading to a suitable control device or evaluating device Naturally, it is also possible to guide the contacts of the temperature sensor out of the winding body in another way. It is possible, for example, to cast the contacts in the winding body together with the temperature sensor during production of the winding body.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic view showing a lamination stack with corresponding windings as is known from the prior art,

FIG. 2 is a schematic side view showing a winding body known from the prior art; and

FIG. 3 is a sectional view of the winding body according to the invention.

### DETAILED DESCRIPTION OF THE PRESENTLY PREFERRED EMBODIMENTS

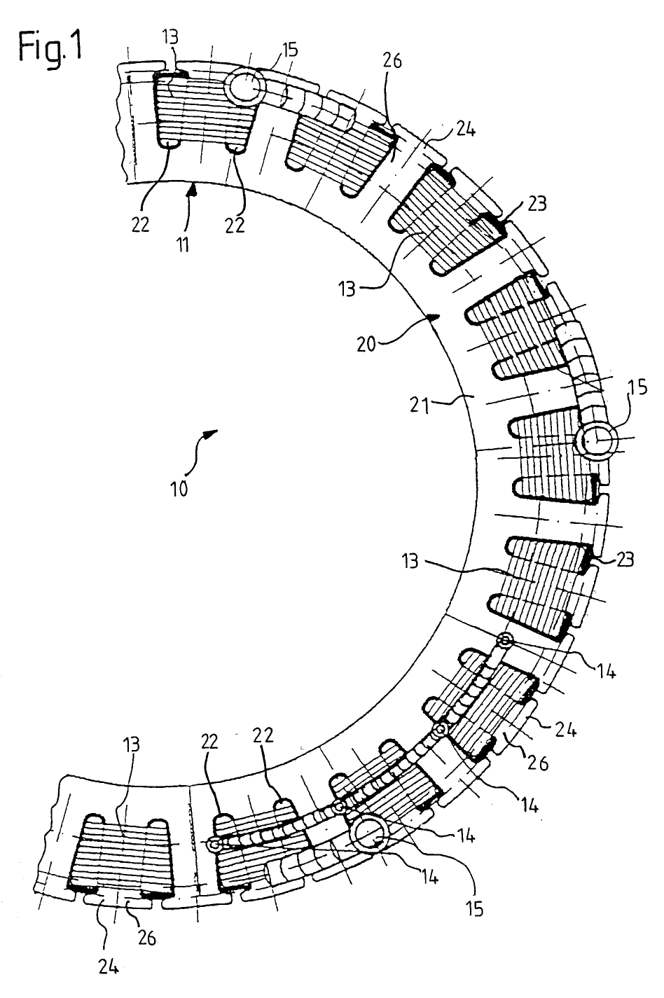

FIG. 1 shows a partial area of an electromagnetomechanical converter 10 constructed as a permanently excited synchronous machine. The partial area shown in the drawing is a partial view of a stator 11. The partial area of the stator 11 shown in FIG. 1 serves for an overview of how the individual elements are arranged in relation to one another. This stator 11 is a variant of a solution that is already known from the prior art. The stator 11 has a lamination stack 20 which is forced from a yoke 21 and a quantity of winding teeth 24. A one-part lamination stack 20 is shown in the present embodiment example.

Some of the winding teeth 24, in the present example, every second winding tooth 24, carry an electrical winding 13. In the example according to FIG. 1, no winding bodies have been inserted, so that the windings 13 must be manually inserted in corresponding slots 22 around the winding teeth 24. The windings 13 are associated with individual strands, and the windings associated with a common strand are connected. With a three-phase machine, the stator 11 has See strands to which current is applied at a 120-degree phase offset. The individual strands are formed by the ends 16 of the windings 13 which are guided together in a corresponding manner. The individual strands are guided to corresponding lead connections 15. A number of temperature sensors 14 are provided in order to measure the heat occurring in the stator during operation of the electric machine 10.

Corresponding slot wedges 23 are provided to prevent the windings 13 from slipping out of the slots 22 unintentionally; these slot wedges 23 are made of paper and are attached to the windings from the outside at the conclusion of the winding process. The slot wedges 23 form a mechanical resistance which should prevent the windings 13 from moving outward unintentionally in radial direction—considered from the yoke 21.

The one-part embodiment form of the lamination stack 20 shown in FIG. 1 has the disadvantages described above in connection with the prior art. In order to avoid these disadvantages, the winding 13 can be wound on corresponding winding bodies 30.

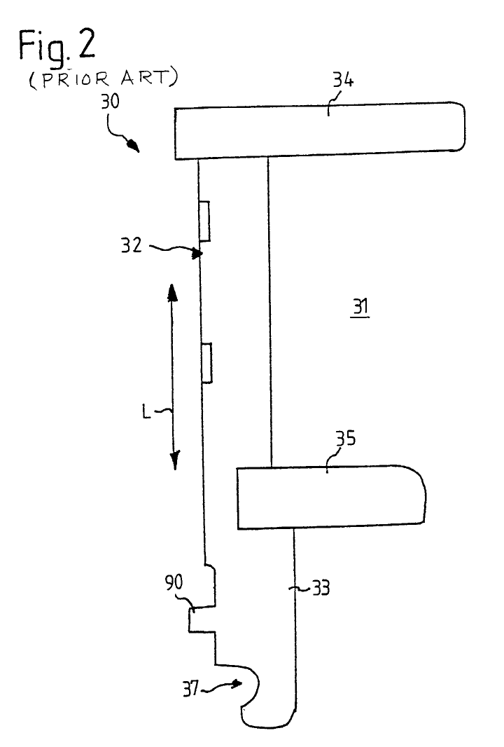

FIG. 2 shows a winding body 30 such as is already known from the prior art. The winding body 30 has a winding area 31 for the winding 13 which is formed by a winding carrier 32 and two legs 34, 35 which define the winding area 31 in axial direction L and are connected with the winding carrier 32. The winding body 30 further has an elongation area 33 which extends beyond the legs 35. This elongation area 33 serves to receive the respective connection devices. In the embodiment example according to FIG. 1, these connection devices are the wired winding ends 16 of the windings 13 which are combined to form strands and have been insulated and then taped. In order to secure the taping, cutouts 37 are provided in the winding carrier 32 for this purpose. The winding body 30 is fixed to a winding tooth, not shown, by a rigid fixing nose 90.

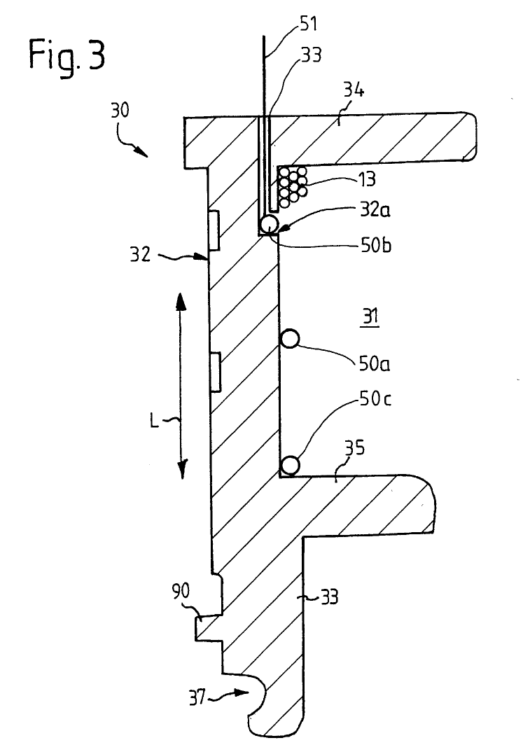

FIG. 3 shows a winding body according to the present invention. In order to determine the temperature in the winding 13, which is only shown schematically, a temperature sensor 50 is provided in addition to the winding body described in FIG. 2 and is arranged in the area of the winding carrier 32. There are numerous possible variants for positioning the temperature sensor 50 which have been designated with the added letters a-e. The temperature sensor 50a is arranged at the winding carrier 32 inside the winding area 31, so that it is fixed between the winding carrier 31 and the winding 13 during the process of winding around the winding body 30, and the thermal contact to the winding is produced. Alternatively, the temperature sensor 50b is located adjacent to the winding area 32 in a cutout 32a. In this way, the temperature sensor 50b is protected during the winding process and is securely held at its predetermined position. At the same time, the temperature sensor 50b is connected with the winding 13 (with the copper) in a defined manner after the winding 13 is completed, so that an accurate measurement of temperature is possible. In another possible arrangement, the temperature sensor 50c is arranged inside the winding area 32 in the area of an edge formed by the winding carrier 32 and the leg 34.

For further processing of the values measured by the temperature sensor 50 (a-c) in a control device or evaluating device, not shown, the temperature sensor 50 has one or more contacts 51 which are connected with the control device or evaluating device by corresponding lines. In the embodiment example shown in the drawing, these contacts S1 are guided through corresponding channels 33 which are formed at least in the winding carrier 32. For the sake of better clarity, only channels for the temperature sensor 50b are shown in FIG. 3, although channels can be provided also for the contacts of temperature sensors 50a,c. However, it is also possible that the temperature sensor 50 and the contacts S1 are molded in the winding carrier 32 of the winding body 30, since the latter is preferably made of plastic and can accordingly be produced by means of injection molding or the like around the sensor and the contacts.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A winding body for receiving a winding of an electromechanical converter, said winding body comprising
a winding carrier,
a pair of legs connected to said carrier and separated by an axial distance, said legs and said carrier forming a winding area for receiving a winding, and
a temperature sensor for measuring the temperature of a winding received in the winding area, said temperature sensor being installed on said winding carrier.

2. A winding body as in claim 1 wherein said winding carrier comprises a cutout which receives said temperature sensor.

3. A winding body as in claim 1 further comprising at last one contact connected to said sensor, said winding carrier comprising at least one channel for receiving said at least one contact.

4. A winding body as in claim 1 wherein said winding carrier is injection molded around said temperature sensor, said sensor being exposed to said winding area.
